(19) United States
(12) Patent Application Publication
(10) Pub. No.: US 2015/0186850 A1
(43) Pub. Date: Jul. 2, 2015

(54) Smart Meeting Creation and Management

(71) Applicant: Microsoft Corporation, Redmond, WA (US)

(72) Inventor: Kanika Ramji, Sammamish, WA (US)

(73) Assignee: MICROSOFT CORPORATION, Redmond, WA (US)

(21) Appl. No.: 14/143,482

(22) Filed: Dec. 30, 2013

(51) Int. Cl. G06Q 10/10; H04L 12/58; H04L 29/08

(52) U.S. Cl. CPC G06Q 10/1095; H04L 67/10; H04L 51/36

(57) ABSTRACT

Smart meeting creation and management is provided. A user interface may be provided for defining smart meeting configuration settings/defaults for creating and managing meetings. Upon receiving a request to create a smart meeting, wherein the request to create a smart meeting defines one or more meeting participants, a smart meeting manager may be operable to automatically determine a meeting time and a meeting location. The smart meeting manager may be further operable to automatically schedule a meeting at the determined time and location. Once a smart meeting is created, the smart meeting manager may manage participant and location responses according to the defined configuration settings.

### BACKGROUND

Electronic calendaring applications are increasingly used to create and manage meetings; however, even with using an electronic calendaring application, organizing and managing a meeting is oftentimes a manual and time consuming process. For example, a user may spend a considerable amount of time finding available slots on meeting participants' calendars, booking rooms, and if a meeting time changes, finding new room availability.

Current electronic calendaring systems have incorporated functionalities to help make meeting organizing simpler, for example, free/busy information sharing, filtering rooms based on vicinity, enabling participants to propose alternate times, etc. While these functionalities help, meeting organization continues to be a tedious task for many users. It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing smart meeting creation and management. Smart meeting configuration settings/defaults for creating and managing meetings may be defined by a meeting organizer or participant or may be prepopulated with default values. Upon receiving a request to create a smart meeting and defining one or more meeting participants, a smart meeting manager may be operable to automatically determine a meeting time and a meeting location, and may be further operable to automatically schedule a meeting at the determined time and location. Once a smart meeting is created, the smart meeting manager may manage participant and location responses according to the defined configuration settings.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of one embodiment of a system for providing smart meeting creation and management;

FIGS. 2A and 2B are an example of a configuration user interface;

FIG. 3 is a flow chart of a method for providing smart meeting creation and management;

FIG. 4 is a block diagram illustrating example physical components of a computing device with which embodiments of the invention may be practiced;

FIGS. 5A and 5B are simplified block diagrams of a mobile computing device with which embodiments of the present invention may be practiced; and

FIG. 6 is a simplified block diagram of a distributed computing system in which embodiments of the present invention may be practiced.

### DETAILED DESCRIPTION

Embodiments of the present invention are directed to providing smart meeting creation and management. As described briefly above, a request to create a meeting, wherein the request to create a meeting defines one or more meeting participants, may be received by a smart meeting manager. The smart meeting manager may be operable to automatically determine a time and a location for the meeting. The smart meeting manager may be further operable to automatically schedule the meeting at the determined time and location. Once a meeting is created, the smart meeting manager may manage participant and location responses according to defined configuration settings.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

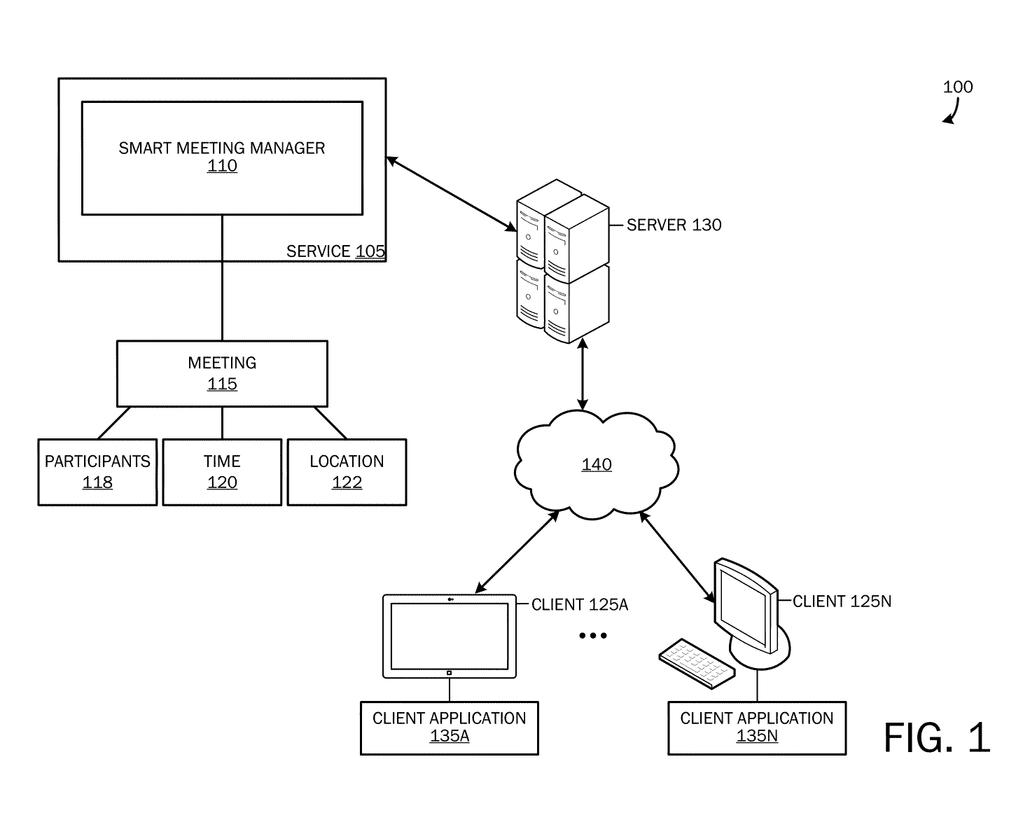

Referring now to the drawings, in which like numerals represent like elements, various embodiments will be described. FIG. 1 is a block diagram illustrating a system architecture 100 for providing smart meeting creation and management. The system 100 includes one or more client devices 125A-N (referred to collectively or individually as client devices 125), communicatively connected to a server device 130 (or a plurality of server devices) by way of a network 140, such as an intranet, extranet, or the Internet. The one or more client devices 125 may include a client application 135A-N (referred to collectively or individually as a client application 135). For example, client application 135 may include a personal information management (PIM) application which may be utilized for emailing, calendaring, task management, contact management, note taking, journaling, web browsing, etc. Client application 135 may be configured to enable a user to use a pointing device (e.g., a mouse, pen/stylus, etc.) and/or to utilize sensors (e.g., touch sensor, accelerometer, hover, facial recognition, voice recognition, light sensor, proximity sensor, gyroscope, tilt sensor, GPS, etc.) on the client computing device 125 to interact with content via a number of input modes. To assist users to locate and utilize functionalities of a given client application 135, a user interface (UI) containing a plurality of selectable functionality controls may be provided.

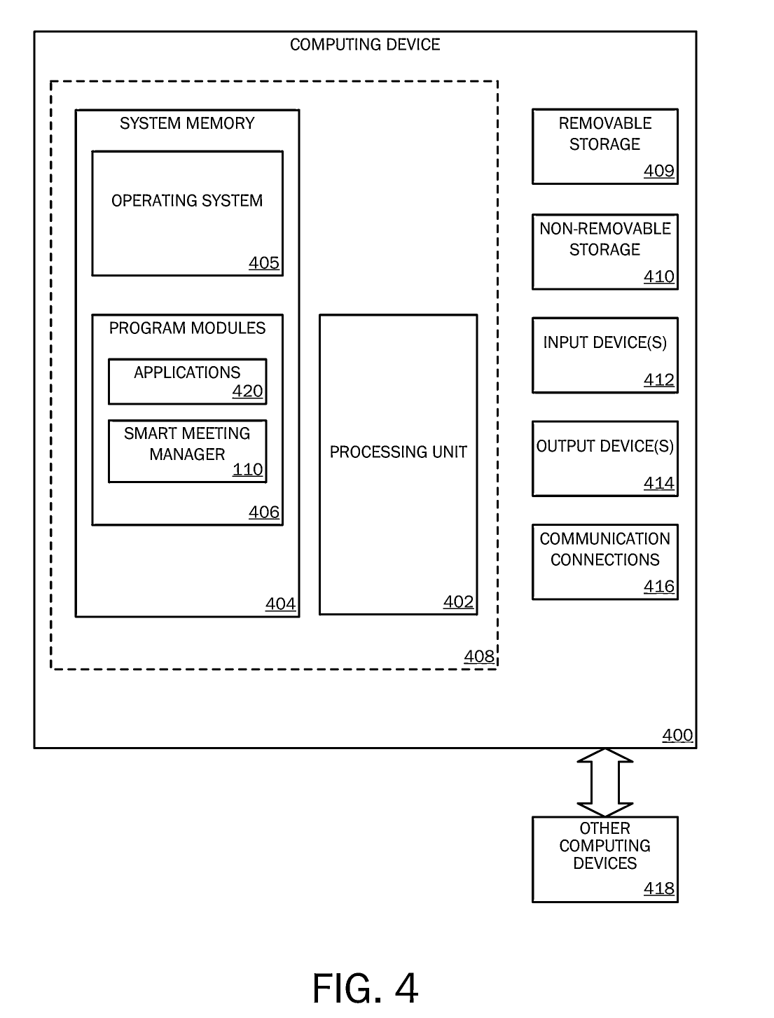

The one or more client devices 125 may be one of a variety of suitable computing devices described below with reference to FIGS. 4 through 6. For example, the one or more client devices 125 may include a tablet computing device, a desktop computer, a mobile communication device, a laptop computer, a laptop/tablet hybrid computing device, a gaming device, or other types of computing devices for executing applications for performing a variety of tasks.

The system architecture 100 includes a smart meeting manager 110 configured to perform operations relating to creation and management of a meeting 115. Upon receiving a request to create a smart meeting 115 and defining one or more participants 118, the smart meeting manager 110 may be operable to automatically determine a meeting time 120 and location 122 and schedule a meeting 115 at the determined time 120 and location 122. A meeting 115 created and managed by smart meeting manager 110 may herein be described as a “smart meeting.” A smart meeting 115 may be created from scratch or may be created from an existing meeting or an electronic message, such as an email. If creating a smart meeting 115 from scratch, a meeting organizer may selectively create a new smart meeting 115 via client application 135. The meeting organizer may be presented with an option to specify names or aliases of required and optional meeting participants 118. According to an embodiment, a meeting time 120 may be pre-populated with a time range (e.g., “tomorrow,” “next week,” “in the next two weeks,” etc.). A time range may be manually overridden with a specific meeting time 120 or may be manually overridden with another time range option. According to an embodiment, the smart meeting manager 110 may be configured to automatically select an available location 122 within a certain vicinity for the smart meeting 115. Alternatively, location options may be provided from which the meeting organizer can choose (e.g., “my office,” “nearby coffee shop,” “online meeting,” etc.), or the meeting organizer can selectively input a location 122 of his/her choice. According to an embodiment, other meeting options (e.g., importance, reminder, show as, etc.) may be manually specified by the meeting organizer.

As mentioned previously, a smart meeting 115 may be created from an existing meeting or from an electronic message, such as an email. According to an embodiment, when an email or a meeting request is selected, an option may be provided in a user interface of client application 135 to create a new meeting 115. Accordingly, a new meeting request may be opened, and participant 118 and subject fields in the new meeting request may be automatically populated with the same information as that of the root message, email, or meeting request.

According to an embodiment, once a smart meeting is created, the smart meeting manager 110 may manage participant and location responses according to defined configuration settings. For example, if a required participant declines a meeting, the smart meeting manager 110 may automatically find an alternative time slot on the participant's calendar. If a declined response for a room is received, the smart meeting manager 110 may automatically find an available room. Additionally, if a meeting time is changed, the smart meeting manager 110 may be operable to automatically find an available room for the new meeting time. The smart meeting manager 110 may be configured by a user to allow another user or users to be a co-owner of a meeting. Accordingly, a co-owner may be enabled to modify a meeting.

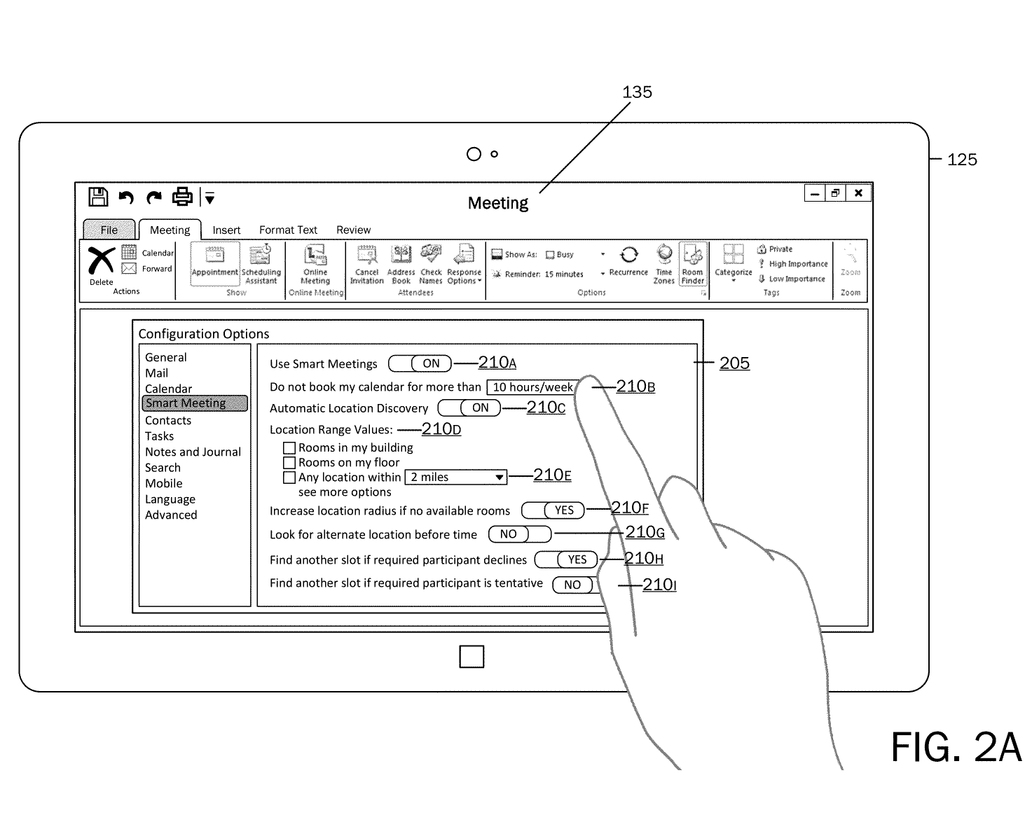

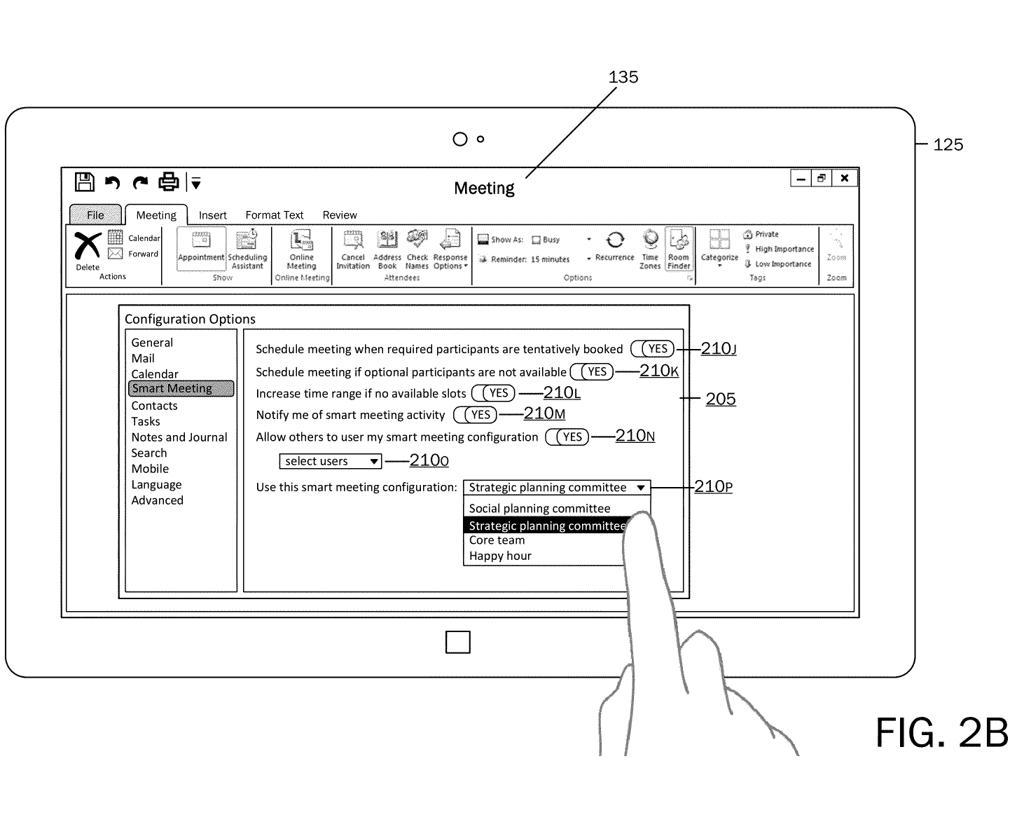

According to embodiments, a configuration user interface may be provided, enabling a meeting organizer or participant 118 to define certain configuration settings/defaults for creating and managing smart meetings 115. Some settings may be pre-configured default values which may be overridden with custom values. According to an embodiment, a meeting organizer's or participant's settings may be shared across client applications 135 that the person uses. An example of a configuration user interface 205 is illustrated in FIGS. 2A and 2B. The example shown includes a sampling of various configuration setting options 210A-P that may be provided. As should be appreciated, the smart meeting configuration setting options 210A-P are not limited to the example options shown in FIGS. 2A and 2B; smart meeting configuration user interface 205 may comprise more or fewer configuration setting options than are shown.

Configuration setting options 210 may include an option (210A) whether to use the smart meeting manager 110 to create and manage smart meetings 115.

Another option (210B) may be provided for allowing a user (e.g., organizer, participant 118) to specify a limit on the amount of time he/she can be scheduled for meetings 115 in a given time period. For example and as illustrated in FIG. 2A, a user may select to constrain his/her calendar to allow for no more than 10 hours in a week to be booked for meetings 115. If a meeting request for a meeting 115 is received for a user and if the specified maximum number of meeting hours allowed per week will be exceeded upon accepting the meeting request, the meeting request may be automatically declined. The user may be enabled to override this setting by manually accepting a meeting request.

Another option (210C) may be provided for allowing or disallowing automatic location discovery. If automatic location discovery is enabled, smart meeting manager 110 may be enabled to find a meeting location 122 based on the user's (i.e., organizer's) current location.

Additionally, a user may be able to specify location preference options (210D) for which smart meeting manager 110 may use for determining a location 122 for a smart meeting 115. For example, a user may select such values as “rooms in my building,” “rooms on my floor,” “any location within a selectable distance (210E),” etc.

Another option (210F) may be provided for allowing a user to allow smart meeting manager 110 to increase a search radius for a location 122 if no locations 122 within the selected location radius are available.

Configuration setting options 210 may include options for management of smart meetings 115. For example, an option (210G) may be provided for allowing a user to select whether or not to look for an alternate location 122 before meeting time. For example, if a smart meeting 115 is set up and the location 115 becomes unavailable and if the organizer has selected to enable looking for an alternate location 122 before time, smart meeting manager 110 may automatically search for an alternative location 122 for the meeting 115.

Options (210H,I) may be provided for enabling smart meeting manager 110 to find an alternate time slot 120 if a required participant 118 declines a meeting request or tentatively accepts a meeting request. Smart meeting manager 110 may retry finding an alternate time slot 120 up to a default number or a user-selected number of received declines or tentative acceptances.

An option (210J) may be provided for allowing or disallowing smart meeting manager 110 to schedule a meeting 115 during a time that a required participant 118 is tentatively booked.

An option (210K) may be provided for allowing or disallowing smart meeting manager 110 to schedule a meeting 115 during a time that an optional participant 118 is not available.

An option (210L) may be provided for increasing a time range if no available time slots 120 to schedule a meeting 115 are found within the time range. For example, if the option to increase a time range if no available time slots 120 within the range are found is enabled, and if a default or user-selected time range is “1 week,” and there is not a commonly available time slot in the required participants' 118 (and optional participants' 118 if specified) calendars during the time range, the time range may be automatically increased to find a commonly available time slot 120.

An option (210M) may be provided for enabling smart meeting activity notifications. For example, if a required participant 118 declines a meeting request and smart meeting manager 110 reschedules the meeting 115 during an alternate time slot 120, a meeting organizer may specify whether or not he/she would like to be notified of the schedule change and details of the schedule change.

An option (210N) may be provided for selecting whether to allow other users to use a meeting organizer's smart meeting configuration settings. If a meeting organizer selects to share his/her smart meeting configuration settings with another user, an option (210O) may be provided for selecting which user(s) or group of users with which to share his/her configuration settings. For example, a manager may selectively choose to share his/her configuration settings 210 with his/her team. According to an embodiment, an inherited smart meeting configuration may be synced by a background asynchronous process to user profiles at a predetermined time interval to update for changes. A notification may be provided to users about updated smart meeting configuration settings.

If a user has more than one smart meeting configuration, an option (210P) may be provided for enabling the user to select which configuration to use.

As described above, smart meeting configuration setting options 210A-P are not limited to the example options shown in FIGS. 2A and 2B; smart meeting configuration user interface 205 may comprise more or fewer configuration setting options than are shown and described.

In order to facilitate communication with the smart meeting manager 110, one or more callback routines, may be implemented. Standard transports, encodings, and protocols may be used to exchange information on various platforms via various networks 140, including a set of standards that describe the syntax and semantics of software communication. According to an embodiment, the smart meeting manager 110 may be powered by a server side service 105 that may be installed as part of server 130. While the smart meeting manager 110 is illustrated within an online service 105, the smart meeting manager 110 may be stored and used on a single computing device. The functionality of the smart meeting manager 110 may be split between service 105 and some other location. Service 105 may be a cloud based and/or enterprise based service that may be configured to provide services, including services that create appointments (e.g. PIM services, productivity services and the like).

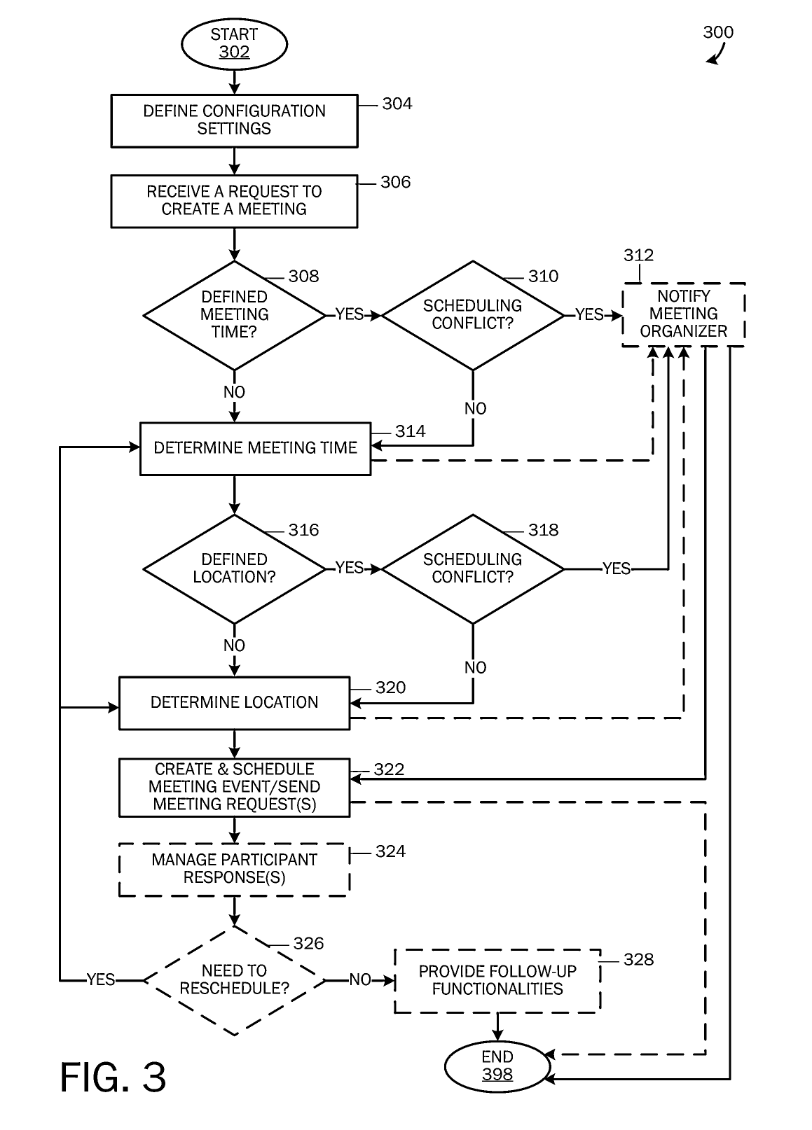

FIG. 3 is a flow chart showing one embodiment of a method 300 for providing smart meeting 115 creation and management. The method 300 starts at OPERATION 302 and proceeds to OPERATION 304 where smart meeting configuration settings may be defined. As described above, a variety of smart meeting configuration setting options 210 may be provided, which may be preconfigured with default values and/or manually defined by a user (i.e., meeting organizer, participant 118).

The method 300 may proceed to OPERATION 306, where a request to create a smart meeting 115 is received. According to one embodiment, the request may be a selection to create a new smart meeting 115 from a client application 135, for example, a PIM or calendaring application. According to another embodiment, the request may be a selection to create a smart meeting 115 from an electronic message, such as an email or from an existing meeting request.

According to embodiments, the request to create a new smart meeting 115 may define one or more meeting participants 118, which may include required and optional participants. If the request is initiated by a selection to create a new smart meeting 115 from scratch, the meeting organizer may input one or more required and optional participants. If the request is initiated by a selection to create a smart meeting 115 from an electronic message, such as an email or from an existing meeting request, the participant(s) 118 may be automatically defined. That is, a participant field in the smart meeting 115 request may be automatically populated with names or aliases of senders and recipients in the message, email, email string, or existing meeting request. A subject field may also be automatically populated with a same subject as the message, email, or existing meeting request.

The method 300 may then proceed to DECISION OPERATION 308, where a determination may be made as to whether the received request to create a smart meeting 115 comprises a defined specific meeting time. If a determination is made that the received request to create a smart meeting 115 does not comprise a defined specific meeting time, for example, if a time range is defined, the method 300 may proceed to OPERATION 314, where an available meeting time 120 within the time range and according to smart meeting configuration settings may be determined. The time range may be a default pre-populated time range, or may be a time range manually selected by the meeting organizer.

If a determination is made that a specific meeting time is defined in the received request to create a smart meeting 115 at DECISION OPERATION 308, for example, if a meeting organizer overrides a time range with a specific meeting time, the method 300 may proceed to DECISION OPERATION 310. At DECISION OPERATION 310, a determination may be made as to whether a defined participant 118, which may include the meeting organizer, has a scheduling conflict during the defined specific meeting time. If a determination is made that a participant 118 has a scheduling conflict, the method 300 may optionally proceed to OPERATION 312, where a notification of the scheduling conflict may be provided to the meeting organizer. According to an embodiment, a notification may be provided according to smart meeting configuration settings. For example, if the meeting organizer selects to be notified of scheduling conflicts, a notification of the scheduling conflict may be provided to him/her. According to an embodiment, one or more alternative meeting times may be suggested. The meeting organizer may be enabled to schedule and/or manage a meeting 115 manually.

If a determination is made at DECISION OPERATION 310 that there are no scheduling conflicts with defined participants 118 or with select defined participants 118 as specified by smart meeting configuration settings, the method 300 may proceed to OPERATION 314, where the defined specific meeting time 120 may be determined as the meeting time 120 of the smart meeting 115.

The method 300 may proceed to DECISION OPERATION 316, where a determination may be made as to whether the received request to create a smart meeting 115 comprises a defined specific location. If a determination is made that the received request to create a smart meeting 115 does not comprise a defined specific meeting location, for example, if an option is selected or preconfigured to automatically find a meeting location 122, the method 300 may proceed to OPERATION 320, where an available meeting location 122 within a predefined location radius or other location setting value according to smart meeting configuration settings may be determined. The location radius or other location setting value may be a prepopulated default setting or may be manually selected by the meeting organizer.

If a determination is made that a specific meeting location is defined in the received request to create a smart meeting 115 at DECISION OPERATION 316, for example, if a meeting organizer overrides an option 210 to automatically find a room or meeting location 122 with a specific meeting location, the method 300 may proceed to DECISION OPERATION 318. At DECISION OPERATION 318, a determination may be made as to whether there is a scheduling conflict with the defined specific location during the determined meeting time 120. If a determination is made that there is a scheduling conflict with the defined specific location during the determined meeting time 120, the method 300 may optionally proceed to OPERATION 312, where a notification of the scheduling conflict may be provided to the meeting organizer according to smart meeting configuration settings. According to an embodiment, one or more alternative meeting locations may be suggested.

If a determination is made at DECISION OPERATION 318 that there are no scheduling conflicts with the defined specific location during the determined meeting time 120 as specified by smart meeting configuration settings, the method 300 may proceed to OPERATION 320, where the defined specific location may be determined as the meeting location 122 of the smart meeting 115.

The method 300 may proceed to OPERATION 322, where a smart meeting 115 event may be created and the defined participants 118, the determined meeting time 120, and the determined meeting location 122 may be scheduled. A meeting request for the smart meeting 115 may be sent to the defined participants 118.

The method 300 may proceed to OPERATION 324, where participant responses may be managed according to smart meeting configuration settings. According to embodiments, if a participant 118 is not available, smart meeting manager 110 may search for and determine an alternate meeting time 120 and/or meeting location 122 according to smart meeting configuration settings (e.g., a “find another slot if required participant declines” configuration setting option 210H, “find another slot if required participant is tentative” configuration setting option 210I, etc.). Smart meeting manager 110 may search for and determine an alternate meeting time 120 and/or meeting location 122 up to a predetermined or manually configured number of times after a declination or tentative acceptance response from a participant 118 is received. If a notification configuration setting option 210M in the meeting organizer's profile is on, a notification may be provided to the meeting organizer with information about automated smart meeting activity (e.g., participant response management and meeting time 120 rescheduling).

According to an embodiment, if a “find alternate time” configuration setting option 210 in the meeting organizer's profile is on, smart meeting manager 110 may automatically identify a meeting time 120 within a time range if specified or preconfigured that is available for all participants 118 or for select participants 118 as specified by smart meeting configuration settings. A meeting location 122 may also be scheduled. The meeting organizer or any allocated co-owners may be enabled to manually change a meeting time 120. If a new meeting time 120 is selected, a new meeting location 122 may be searched for and scheduled for the updated meeting time 120.

According to an embodiment, meeting scheduling and acceptance/declination patterns on a user's calendar may be monitored and analyzed. Accordingly, smart meeting manager 110 may automatically prioritize a meeting 115 according to a detected pattern. A prioritized meeting may have a higher management priority in a queue of meetings smart meeting manger 110 is managing. Hidden priorities may be assigned to certain meetings in a user's calendar. For example, a meeting 115 may be prioritized as a critical meeting if the user typically or almost always accepts meeting requests from the meeting organizer of the said meeting 115. As another example, a meeting 115 may be prioritized as a critical meeting if the defined participants 118 are individuals with whom a meeting organizer frequently schedules meetings 115.

According to an embodiment, a reminder notification to respond to a meeting request may be automatically sent according to a monitored acceptance rate. For example, if a predetermined percentage (e.g., 80%) of required participants 118 accepts a meeting request, an email may be automatically generated and sent to the remaining participants who have not yet accepted the meeting request. The email may include information about the percentage of participants or the names of participants who have accepted the meeting request. According to an embodiment, if a predetermined rate of participants 118 do not accept a meeting request within a certain time window, smart meeting manager 110 may be triggered to automatically reschedule the meeting 115.

According to an embodiment, user location patterns may also be monitored and analyzed for determining meeting time 120 and/or meeting location 122. For example, if a meeting organizer schedules a meeting 115 that is scheduled at a given location and another meeting 115 with a common one or more participants 118 in the same location is identified, smart meeting manager 110 may search for a meeting time slot adjacent to the existing meeting 115. Accordingly, automatic bundling of meetings 115 based on location 122 may be provided.

According to an embodiment, a meeting 115 may be specified as a recurring meeting, wherein a meeting frequency and/or duration may be defined. Smart meeting manager 110 may search for and determine a meeting time 120 best suited for the recurrence based on the defined participants' calendars. In cases where an instance of a recurring meeting 115 cannot be accommodated in a scheduled meeting location 122, smart meeting manager 110 may search for and determine an alternative meeting location 122 for the instance.

At DECISION OPERATION 326, if a determination is made that a meeting 115 needs to be rescheduled, for example, according to participant response management embodiments described above, the method 300 may return to OPERATION 314 or 320 where a new meeting time 120 and/or meeting location 122 may be determined.

If a determination is made at DECISION OPERATION 326 that a meeting 115 does not need to be rescheduled, the method 300 may proceed to OPERATION 328, where meeting follow-up functionalities may be provided. For example, a meeting organizer may utilize a smart meeting instance to take notes and to select action items to tag with smart meeting reminders. Accordingly, automatic action item reminders may be automatically triggered, wherein a reminder may be sent to a participant who has a follow-up action item from the meeting 115. The method 300 may end at OPERATION 398.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-6 and the associated descriptions provide a discussion of a variety of operating environments in which embodiments of the invention may be practiced. However, the devices and systems illustrated and discussed with respect to FIGS. 4-6 are for purposes of example and illustration and are not limiting of a vast number of computing device configurations that may be utilized for practicing embodiments of the invention, described herein.

FIG. 4 is a block diagram illustrating physical components (i.e., hardware) of a computing device 400 with which embodiments of the invention may be practiced. The computing device components described below may be suitable for the client device 125 and/or server 130 described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 420, such as the smart meeting manager 110. The operating system 405, for example, may be suitable for controlling the operation of the computing device 400. Furthermore, embodiments of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the stages of the method 300 illustrated in FIG. 3. Other program modules that may be used in accordance with embodiments of the present invention may include applications such as electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing smart meeting 115 creation and management may be operated via application-specific logic integrated with other components of the computing device 400 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

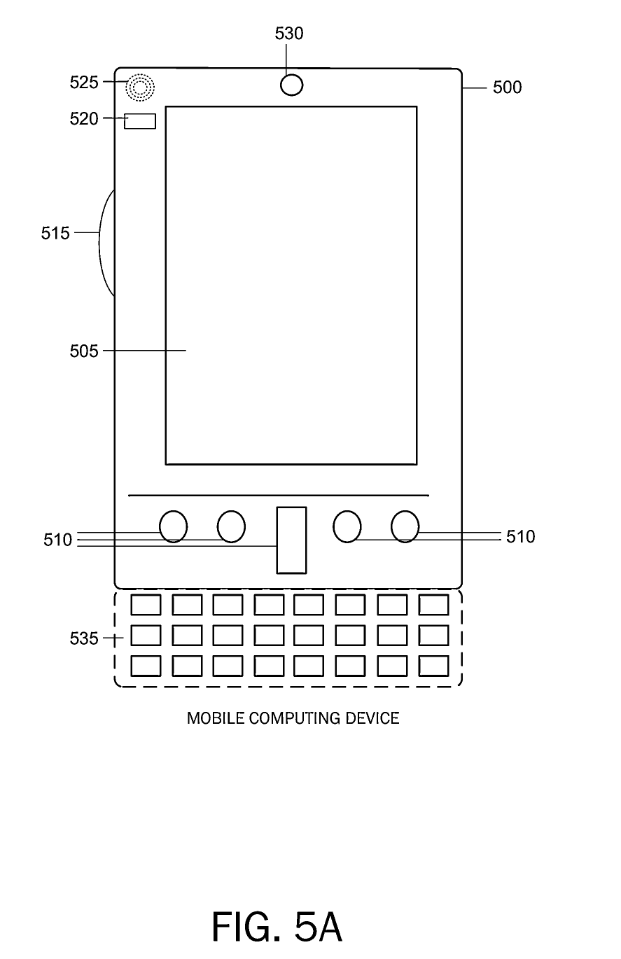

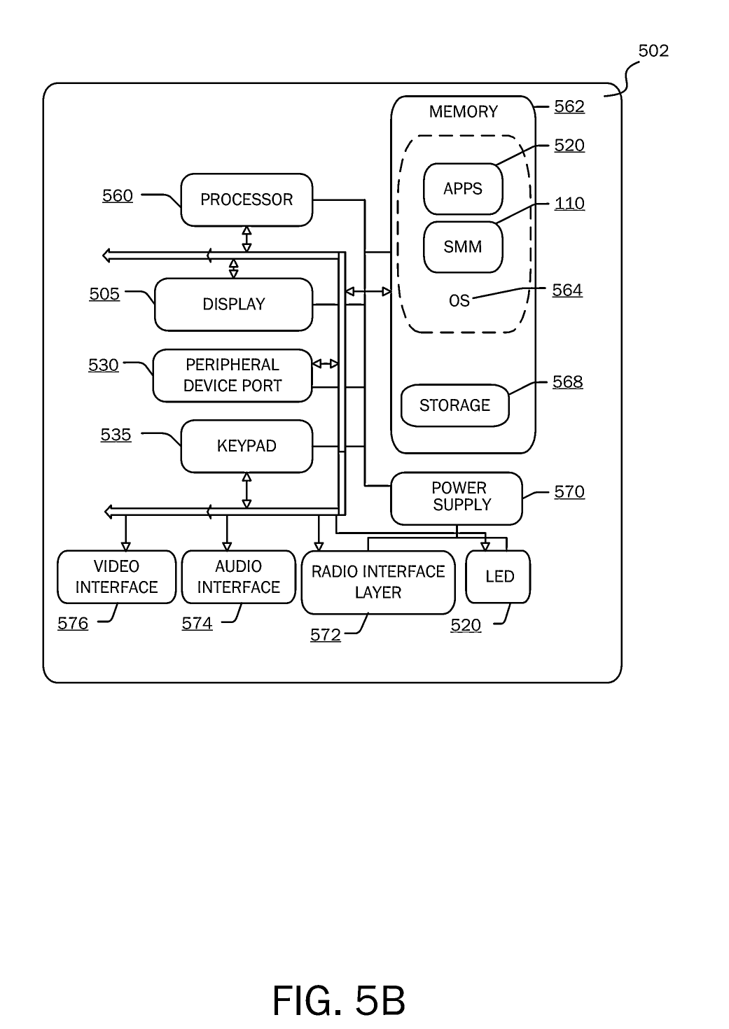

FIGS. 5A and 5B illustrate a mobile computing device 500, for example, a mobile telephone, a smart phone, a tablet personal computer, a laptop computer, and the like, with which embodiments of the invention may be practiced. With reference to FIG. 5A, one embodiment of a mobile computing device 500 for implementing the embodiments is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative embodiments, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some embodiments, the mobile computing device 500 incorporates a vibration transducer for providing the user with tactile feedback. In yet another embodiment, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one embodiment of a mobile computing device. That is, the mobile computing device 500 can incorporate a system (i.e., an architecture) 502 to implement some embodiments. In one embodiment, the system 502 is implemented as a “smart phone” capable of running one or more applications (e.g., browser, e-mail, calendaring, contact managers, messaging clients, games, and media clients/players). In some embodiments, the system 502 is integrated as a computing device, such as an integrated personal digital assistant (PDA) and wireless phone.

One or more application programs 520 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 520 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 520 via the operating system 564, and vice versa.

The visual indicator 520 may be used to provide visual notifications and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present invention, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

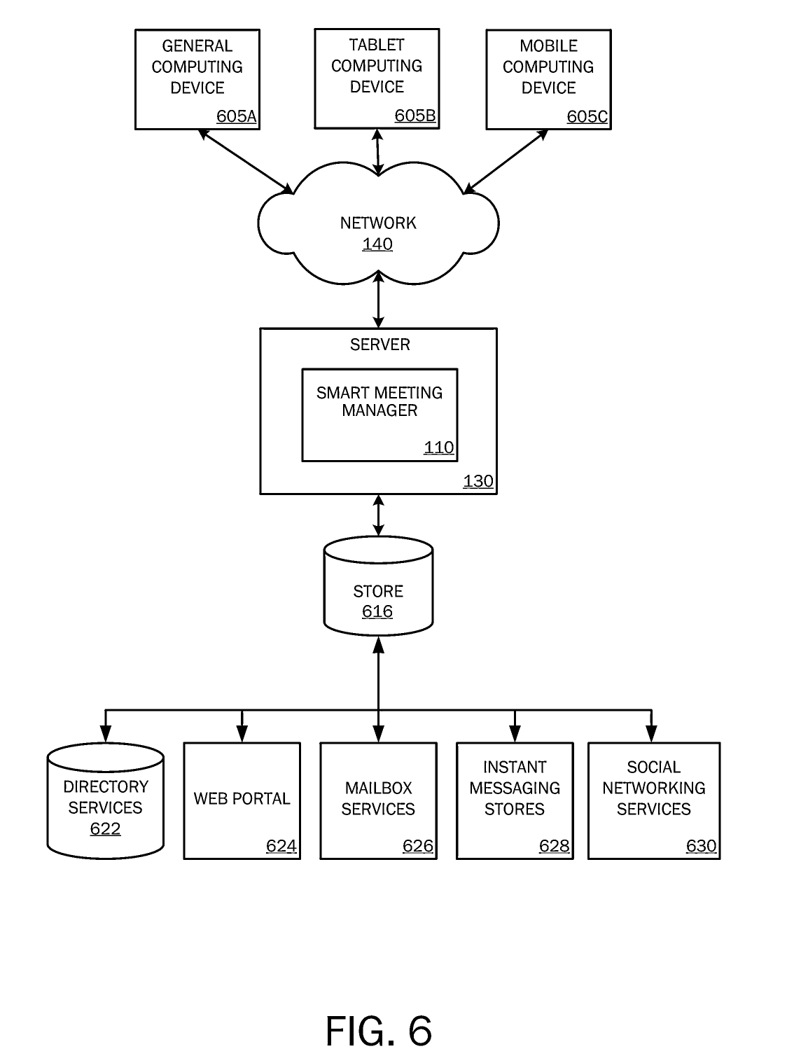

FIG. 6 illustrates one embodiment of the architecture of a system for providing smart meeting 115 creation and management, as described above. Content developed, interacted with, or edited in association with smart meeting manager 110 may be stored in different communication channels or other storage types. For example, various documents may be stored using a directory service 622, a web portal 624, a mailbox service 626, an instant messaging store 628, or a social networking site 630. The smart meeting manager 110 may use any of these types of systems or the like for providing smart meeting 115 creation and management, as described herein. A server 130 may provide smart meeting manager 110 to clients 125. As one example, the server 130 may be a web server providing smart meeting manager 110 over the web. The server 130 may provide smart meeting manager 110 over the web to clients 125 through a network 140. By way of example, the client computing device 125 may be implemented and embodied in a personal computer 605A, a tablet computing device 605B and/or a mobile computing device 605C (e.g., a smart phone), or other computing device. Any of these embodiments of the client computing device may obtain content from the store 616.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for providing smart meeting creation and management, the method comprising:
defining meeting configuration settings;
receiving a request to create a meeting;
defining one or more meeting participants;
determining a meeting time;
determining a meeting location; and
automatically scheduling a meeting instance for the one or more meeting participants at the determined meeting time and the determined meeting location according to the meeting configuration settings.

2. The method of claim 1, wherein receiving a request to create a meeting comprises receiving a request to create a meeting from an electronic message, email, or from an existing meeting request.

3. The method of claim 2, wherein:
if the request to create a meeting is from an electronic message or email, defining one or more meeting participants comprises automatically populating a participant field with recipients and a sender of the electronic message or email; and
if the request to create a meeting is from an existing meeting request, defining one or more meeting participants comprises automatically populating a participant field with meeting participants in the existing meeting request.

4. The method of claim 1, wherein defining meeting configuration settings comprises defining user-specified configuration settings and prepopulated default configuration settings.

5. The method of claim 1, wherein determining a meeting time comprises:
receiving a defined specific meeting time or receiving a defined time range;
if a defined specific meeting time is received, searching the meeting participants' calendars;
if a time slot is available in the meeting participants' calendars at the defined specific meeting time, determining the time slot at the defined specific meeting time as the meeting time of the meeting; and
if a defined time range is received, searching the defined time range in the meeting participants' calendars; and
if a time slot is available in the meeting participants' calendars within the defined time range, determining an available time slot within the defined time range as the meeting time of the meeting.

6. The method of claim 1, wherein determining a meeting location comprises:
receiving a defined specific meeting location or receiving a defined location range;
if a defined specific meeting location is received, searching the defined specific meeting location's calendar for a scheduling conflict during the determined meeting time;
if a time slot is available in the defined specific meeting location's calendar during the determined meeting time, determining the defined specific meeting location as meeting location for the meeting; and
if a defined location range is received, searching calendars of one or more locations within the defined location range for an available time slot; and
determining a location within the defined location range with an available time slot during the determined meeting time as the meeting location of the meeting.

7. The method of claim 1, further comprising:
sending a meeting request for the meeting to the one or more meeting participants; and
managing meeting participant responses according to the meeting configuration settings.

8. The method of claim 7, wherein managing meeting participant responses according to the meeting configuration settings comprises one or more of:
monitoring acceptance patterns;
automatically prioritizing meetings according to the acceptance patterns;
automatically finding and scheduling an alternate meeting time if a declination from a required participant is received;
automatically finding and scheduling an alternate meeting time if a tentative acceptance from a required participant is received;
if scheduling conflict for a meeting location is detected, automatically finding and scheduling an alternate meeting location;
providing notifications of responses and rescheduling activities to a meeting organizer;
detecting a predetermined acceptance rate of required participants and automatically sending a notification to participants who have not yet accepted a meeting request of the acceptance rate; and
automatically rescheduling a meeting if a predetermined percentage of participants do not accept a meeting request within a predetermined time frame.

9. The method of claim 1, further comprising:
receiving a selective indication to add a co-owner to a meeting; and
allowing the co-owner to edit meeting properties.

10. The method of claim 1, wherein receiving a request to create a meeting comprises receiving a request to create a recurring meeting, the request to create a recurring meeting defining a meeting frequency and a meeting duration.

11. The method of claim 10, wherein determining a meeting time for the recurring meeting comprises searching participants' calendars for an available time slot favorable for the recurring meeting at the defined frequency.

12. The method of claim 10, further comprising:
receiving an indication of a scheduling conflict with the meeting location for a recurring meeting instance; and
automatically determining an alternate meeting location for the recurring meeting instance.

13. The method of claim 1, further comprising:
receiving an indication of a tagged action item associated with a meeting participant; and
automatically providing an action item reminder to the participant.

14. A system for providing smart meeting creation and management, the system comprising:
one or more processors; and
a memory coupled to the one or more processors, the one or more processors operable to:
define meeting configuration settings;
receive a request to create a meeting;
define one or more meeting participants;
determine a meeting time;
determine a meeting location; and
automatically schedule a meeting instance for the one or more meeting participants at the determined meeting time and the determined meeting location according to the meeting configuration settings.

15. The system of claim 14, wherein in determining a meeting time, the one or more processors are operable to:
receive a defined specific meeting time or receive a defined time range;
if a defined specific meeting time is received, search the meeting participants' calendars;
if a time slot is available in the meeting participants' calendars at the defined specific meeting time, determine the time slot at the defined specific meeting time as the meeting time of the meeting; and
if a defined time range is received, search the defined time range in the meeting participants' calendars; and
if a time slot is available in the meeting participants' calendars within the defined time range, determine an available time slot within the defined time range as the meeting time of the meeting.

16. The system of claim 14, wherein in determining a meeting location, the one or more processors are operable to:
receive a defined specific meeting location or receive a defined location range;
if a defined specific meeting location is received, search the defined specific meeting location's calendar for a scheduling conflict during the determined meeting time;
if a time slot is available in the defined specific meeting location's calendar during the determined meeting time, determine the defined specific meeting location as meeting location for the meeting; and
if a defined location range is received, search calendars of one or more locations within the defined location range for an available time slot; and
determine a location within the defined location range with an available time slot during the determined meeting time as the meeting location of the meeting.

17. The system of claim 14, wherein the one or more processors are further operable to:
send a meeting request for the meeting to the one or more meeting participants; and
manage meeting participant responses according to the meeting configuration settings, wherein in managing meeting participant responses according to the meeting configuration settings, the one or more processors are operable to perform one or more of:
monitor acceptance patterns;
automatically prioritize meetings according to the acceptance patterns;
automatically find and schedule an alternate meeting time if a declination from a required participant is received;
automatically find and schedule an alternate meeting time if a tentative acceptance from a required participant is received;
if scheduling conflict for a meeting location is detected, automatically find and schedule an alternate meeting location;
provide notifications of responses and reschedule activities to a meeting organizer;
detect a predetermined acceptance rate of required participants and automatically send a notification to participants who have not yet accepted a meeting request of the acceptance rate; and
automatically reschedule a meeting if a predetermined percentage of participants do not accept a meeting request within a predetermined time frame.

18. The system of claim 14, wherein the one or more processors are further operable to:
receive a selective indication to add a co-owner to a meeting; and
allow the co-owner to edit meeting properties.

19. The system of claim 14, wherein in receiving a request to create a meeting, the one or more processors are operable to:
receive a request to create a recurring meeting, the request to create a recurring meeting defining a meeting frequency and a meeting duration;
search participants' calendars for an available time slot favorable for the recurring meeting at the defined frequency;
determine if there is a scheduling conflict with the meeting location for a recurring meeting instance; and
if there is a scheduling conflict with the meeting location for a recurring meeting instance, automatically determine an alternate meeting location for the recurring meeting instance.

20. A computer readable medium containing computer executable instructions which, when executed by a computer, perform a method for providing smart meeting creation and management, the method comprising:
defining meeting configuration settings, wherein defining meeting configuration settings comprises defining user-specified configuration settings and prepopulated default configuration settings;
receiving a request to create a meeting;
defining one or more meeting participants;
determining a meeting time;
determining a meeting location;
automatically scheduling a meeting instance for the one or more meeting participants at the determined meeting time and the determined meeting location according to the meeting configuration settings;
sending a meeting request for the meeting to the one or more meeting participants; and
managing meeting participant responses according to the meeting configuration settings.
